(19) United States
(12) Patent Application Publication
(10) Pub. No.: US 2007/0201644 A1
(43) Pub. Date: Aug. 30, 2007

(54) TELEPHONE FEATURE SALES TOOL

(75) Inventor: Michael D. Metcalf, Ladera Ranch, CA (US)

Correspondence Address: DAVID L. THOMSON, 4480 BASSWOOD DR., LISLE, IL, 60532, US

(73) Assignee: MDM INTELLECTUAL PROPERTY LLC, Rancho Santa Margarita, CA (US)

(21) Appl. No.: 11/307,672

(22) Filed: Feb. 16, 2006

(51) Int. Cl. H04M 15/00

(52) U.S. Cl. 379/114.28

(57) ABSTRACT

A customer who uses one or more telephone services and in the process of using one of these services, receives a recorded announcement that a new service is available. The customer may accept or decline the new service. If the customer accepts, the new service is automatically configured and the customer is charged for the new service.

### FIELD OF THE INVENTION

The present invention relates to telecommunications systems and methods and, more particularly, to a method for offering, selling, and configuring new services by phone.

### BACKGROUND OF THE INVENTION

Some of the most significant expenses in providing telecommunications services involve getting a potential customer to the point where the customer is receiving and paying for the services. There are four major components to sign-up expenses, (1) making the customer aware of the service, (2) committing the customer to a purchase, (3) setting up the service, and (4) billing for the service. Methods for these sign-up steps include advertising (direct mail, TV, newspaper, web sites), telemarketing, and email, each representing significant costs. What is needed is an inexpensive method of selling and configuring new services.

### SUMMARY OF THE INVENTION

In accordance with one aspect of the invention, the aforementioned problem has been solved and a technological advance achieved by using an automated sales agent to sell and configure services for customers. The invention works by “up-selling” (offering an existing customer additional services at an additional cost) new features to customers who are already using one or more services. The agent makes a potential customer aware of a new service by playing an announcement, inviting the customer to accept or reject the offer, and then, if the customer accepts, configuring the customer's service and adding a corresponding charge to the customer's bill.

### BRIEF DESCRIPTION OF THE DRAWINGS

FIG. 1 shows a high-level flowchart for up-selling a new service.

FIG. 2 shows details of decision block 140 in FIG. 1.

FIG. 3 shows an example hardware architecture for an up-sell system.

### DETAILED DESCRIPTION

In the following description, numerous details are set forth to provide an understanding of the present invention. However, it is to be understood by those skilled in the art that the present invention may be practiced without these details and that numerous variations or modifications from the described embodiments may be possible.

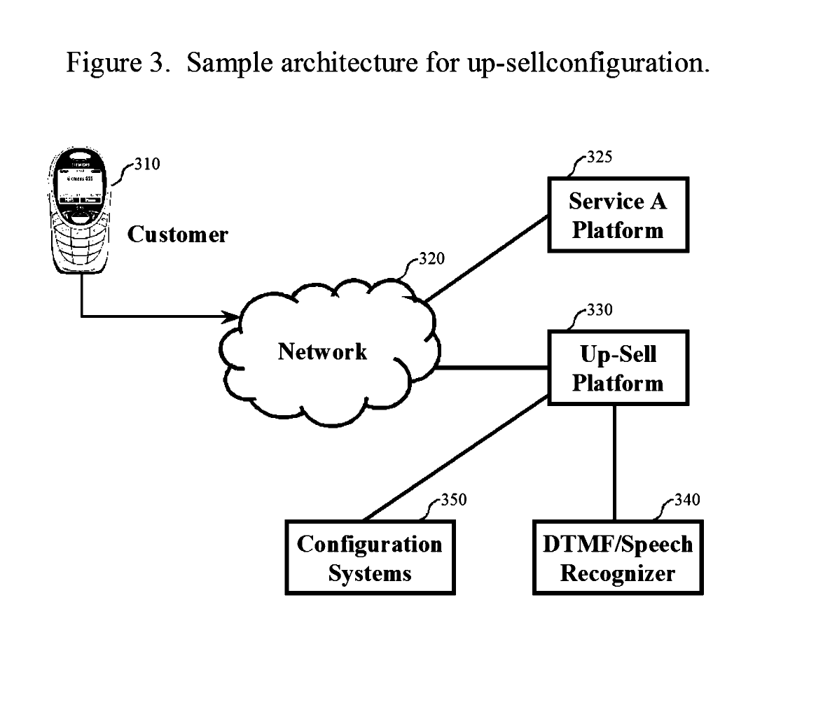

FIG. 3 is an architectural diagram of an up-sell system. Customer 310 is using a given service, which we call Service A, via network 320. Service A is provided by Service A platform 325. In the illustrative example, customer 310 is connected to network 320. In the process of customer 310 using Service A, up-sell platform 330 offers customer 310 a new service, which we denote as Service B. Optional DTMF/speech recognizer 340 recognizes responses from customer 310. Depending on service needs, affordability of the up-sell service, and other factors, DTMF/speech recognizer 340 may offer DTMF and speech recognition, only DTMF recognition, or only speech recognition. Note that DTMF/speech recognizer 340 may be part of or separate from up-sell platform 330. Note also that up-sell platform 330 may be part of or separate from platform 325 used to offer Service A. If customer 310 accepts Service B, up-sell platform 330 uses configuration systems 350 to set up Service B and initiate billing. Up-sell platform 330 may be part of or separate from configuration systems 350. It is to be understood that the architecture diagram in FIG. 3 is illustrative and is only one of many methods that may be used to implement the current invention.

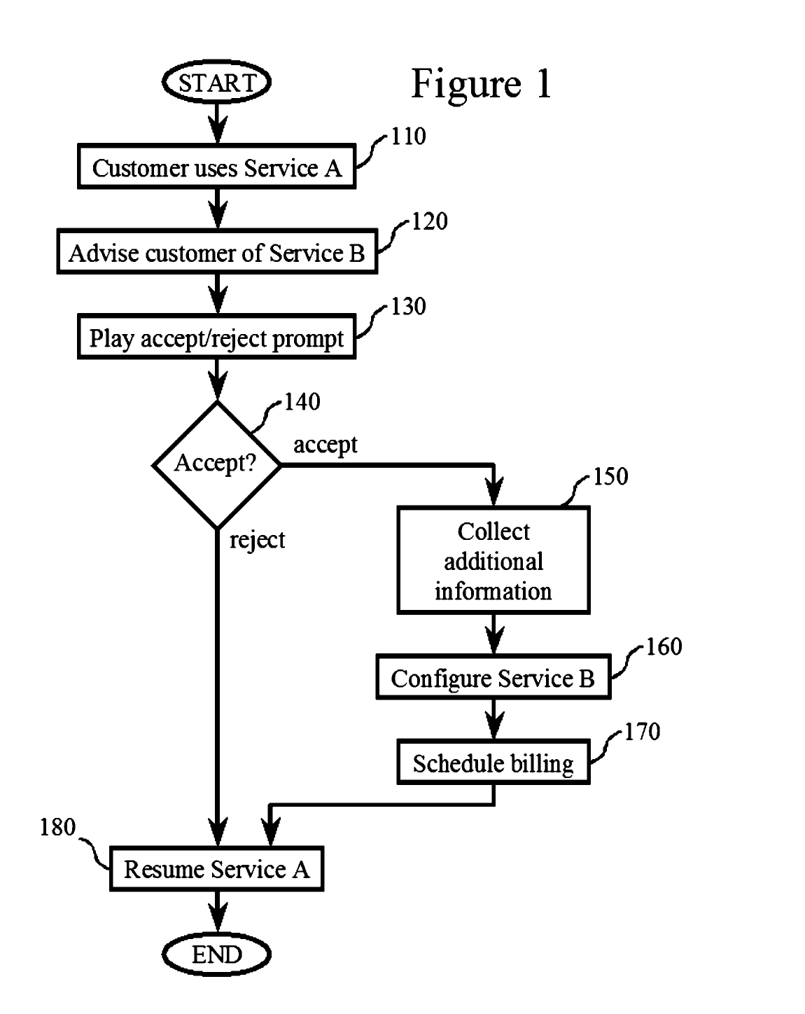

FIG. 1 illustrates the steps in up-selling a new service to a potential customer according the current invention. A potential customer is using an existing service (Service A) in step 110. There are several ways a potential customer may wind up receiving an up-sell offer from an automated sales agent. The potential customer may be a subscriber to an existing service or the potential customer may be using a service that requires no subscription or is subscribed to by a different person. In a first example, a subscriber picks up the phone to make a call, and, instead of the regular dial tone, the subscriber reaches the sales agent. In a second example, the subscriber is communicating with an automated assistant and the automated assistant takes on the role of the automated sales agent by offering the new service. (An automated assistant is a voice response device that uses voice and/or touch-tone to offer services such as call screening, leaving or listening to voicemail, listening to an synthesized voice as it reads email, looking up a name in a directory, changing custom calling features, forwarding calls, talking caller ID (where the name of the calling party is announced), etc.) In a third example, a potential customer reaches the sales agent by calling a subscriber or a service offered to non-subscribers. Note that we refer to the sales agent as the method for up-selling a service, though the sales agent may be an extension of an existing service and does not necessarily need to be a separate voice, software program, or hardware system. Note also that we refer to a “service” as something that could be sold to a customer, but it would also be possible to sell a product (such as a cell phone or other physical item); therefore, when we refer to a “service” in the current invention, the term is also understood to mean “product or service.”

Either before, during, or after the execution of Service A, an announcement is played to the customer in block 120 to advise him/her of a new service, Service B. The customer is then invited to accept the new service or reject the new service in block 130. In block 140, a determination is made as to whether the customer's response corresponds to “accept” or “reject (equivalently, “yes” or “no,” respectively). In one embodiment of the invention, the yes/no determination is made by the agent recognizing a voice response (e.g. saying “yes” or “no”). Alternatively, the agent may accept a touch-tone response (pressing “1” for “yes” or “2” for “no”). Alternatively, the agent may accept either voice or touch-tone. The customer is advantageously prompted in block 130 to provide the form (voice or touch-tone) of the response that the agent will accept. If a touch-tone (also called DTMF) response is expected, a touch-tone detector is used to determine the customer response. If a spoken response such as the words “yes,” “no,” “accept,” or “reject” is expected, an automatic speech recognizer is used to determine the customer response. If the customer rejects the new service, Service A continues in block 180.

If the customer accepts the service, then the system optionally prompts for additional information, if necessary, in block 150. Additional information may include a second confirmation to insure that the customer wants to Service B and did not respond by mistake. Additional information may also be a credit card number for billing, an email address (for, say, a service that sends voice mail to a subscriber's email account), or personal information to verify the customer's identity. In block 160, the agent configures Service B for the customer. For example, if Service B is voicemail, the agent may set up a voicemail box, ask the customer to enter a password, and configure the network so that unanswered calls will be directed to voicemail. For certain complex services or where human action is required, the customer may be transferred to a CSR (customer service representative) as an alternative to automatic configuration in block 160. If it is not practical to configure the service (for example, if a manual step is involved, essential systems are unavailable, or if authorization is required) in real-time, the service is scheduled in block 160 to be configured at a later time.

In block 170, charges for Service B are added to the customer's bill or are scheduled to be added to the bill. The service offer in blocks 120 and 130 may include an incentive such as a time-restricted free trial or a discount during an introductory time period, in which case a data record is created that will cause the correct charges to be added to the bill at the appropriate times.

Once the up-sell process is complete, Service A resumes, if appropriate, in block 180. Alternatively, the customer may begin using Service B or an introduction to Service B immediately.

In one embodiment, Service A is broadcast voicemail, where the new service is announced in a voicemail message sent to a block of customers. In alternative embodiments, Service A may be any telephone service. In the example of broadcast voicemail, the voicemail message advertises Service B and prompts the customer to accept or reject the service. In one embodiment of the invention, the customer is required to accept or reject Service B before the customer is able to continue to use Service A. In another embodiment, the customer may continue to use the Service A, including listening to other voicemail messages, but cannot delete the broadcast voicemail containing an advertisement for Service B until the customer has accepted or rejected Service B.

One illustrative prompt (or, in the case of broadcast voicemail, an illustrative voice message) is as follows:

“Hello, <subscriber name>. I've gone back to school and learned a new trick! I can now give you a wake up call in the morning and then read your calendar to you. I can remind you of appointments or any bills that may be due and then offer to reschedule your meetings or pay your bills—all by voice command. Would you like to try the additional service free of charge for 30-days? Just say “yes” and the feature will be automatically added to your account and the billing program will be notified to charge an extra $1.95 each month unless you cancel within 30-days via the web.”

For purposes of the current invention, a service, as referenced in the text description of the current invention and as Service A and Service B in FIG. 1, may include, but is not limited to, one or more of the following: basic telephone service (i.e. the potential customer is placing a telephone call), long-distance telephone service, flat-rate telephone service, wake-up calls, calendar management (check schedule, make appointments, change appointments, call or send messages to meeting participants, etc.), call waiting, smart dial-tone (replace regular dial with a hotline connection to an autoattendant), call screening (where the caller's name or telephone number is announced so that the called party may accept or reject the call), VoIP (Voice over Internet Protocol), peer-to-peer telephone service, voice dialing, voicemail, automated attendants or receptionists, a service that reads email using a text-to-speech synthesizer, a news service that reports weather, sports, or other news, an automated assistant, a stock quoting and/or trading service, video telephone service, horoscopes or other entertainment, or a new pricing plan for an existing service such as a lower per-minute charge with an additional monthly fee. Another telephone service example is click-to-talk, where an icon on a website or attached to email or resident on the desktop of a PC may be clicked to activate a telephone call. A telephone call, for purposes of this invention, may be a standard voice call, a VoIP call, a peer-to-peer call, a video (with audio and real-time images) call, or any other configuration that allows two parties to communicate.

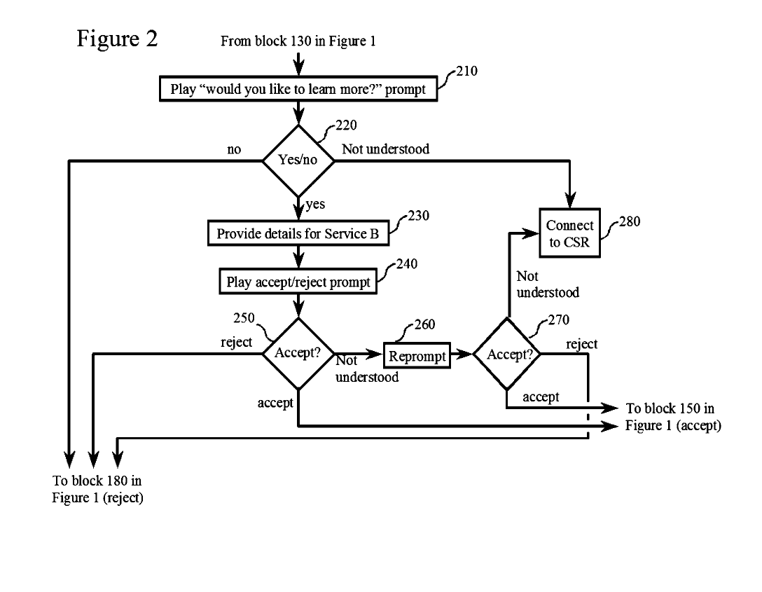

For illustrative purposes, decision block 140 is shown as a binary response by the customer; however, for some services and in response to certain customer responses, it may be necessary to expand the accept/reject portion of the up-sell method to include providing additional information, treating error conditions, and responding to complex (more than simple yes/no) customer input. One example of a more sophisticated version of decision block 140 is shown in FIG. 2.

The flowchart in FIG. 2 follows after block 130 in FIG. 1. Block 210 advantageously asks the customer if he/she would like to learn more about Service B. (It may be that the customer does not need to know more; that the information from block 130 was sufficient and only a “yes” or “no” is required. If no more information is required, blocks 210, 220, and 230 may be skipped.) Note that blocks 130 and 210 may not both be necessary since they perform similar functions; it may be possible to combine them into a single block with one or more prompts. In block 220, a determination is made as to whether the customer's response corresponds to “accept” (or “yes”) or “reject (or “no”). This yes/no determination is made in a similar manner to that of block 140 (described above). In addition to the simple yes/no determination, block 220 allows for a response that is not understood. If the customer does not provide a valid response (for example, if the customer does nothing, presses a touch-tone button other than “1” or “2,” says something other than “yes” or “no” or “accept” or “reject,” or if the customer's response is unrecognizable), then the customer is advantageously transferred to a CSR. Alternatively (instead of connecting to a CSR), the customer may be reprompted one or more times and then, only if the customer fails to provide a recognizable response, optionally connecting to the CSR. In another alternative embodiment, if a yes/no determination cannot be made, Service A resumes in block 180. If the customer declines to learn more (the “no” path from decision block 220), the flowchart continues to block 180 in FIG. 1.

If the customer agrees to learn more (the “yes” path from decision block 220), additional information is provided in block 230 (block 230 is optional and is only necessary if the customer needs more information). The customer is invited to accept or reject the offer in block 240 and a determination of the customer's response is made in decision block 250. If the customer accepts (using a yes/no accept/reject determination as described above), control transfers to block 150 in FIG. 1. If the customer rejects the offer, control transfers to block 180 in FIG. 1. If the customer's response is unrecognizable, then the customer may be reprompted one or more times. Reprompt announcement 260 and decision block 270 illustrate one embodiment or a reprompt strategy where the customer is reprompted once. As with decision block 220, if the customer's response is ultimately unrecognizable, even with reprompts, the agent transfers the call to a CSR (as shown in FIG. 2) or resumes Service A (an alternative embodiment not shown in the figure).

The specific sequence of prompts and responses in FIGS. 1 and 2 are illustrative in terms of the order and content of prompts, the expected responses, whether and when the customer is connected to a CSR, and the number of times a customer is reprompted. Such variations are understood to be within the scope of the current invention.

It is to be understood that this application discloses a system and method using telephone prompts to sell new services to customers using existing services. While the invention is particularly illustrated and described with reference to example embodiments, it will be understood by those skilled in the art that various changes in form, details, and applications may be made therein. For example, prompts and other information may be provided via recorded announcements or via text-to-speech synthesis. Other responses may be elicited from a prospective customer other than “yes” or “no.” For example, the agent may offer several services and invite the prospective customer to accept a service or to learn more by saying the name of the service. In one alternative embodiment, the customer's response is sufficient to offer and bill for service. In an alternative embodiment, the customer is connected to a CSR for verification. In another alternative embodiment, a recording is kept of the customer response to confirm that the customer did authorize the new service and associated charges.

What is claimed is:

1. A method of selling telephone services comprising:
playing an announcement to a customer who is using a first service to advise the customer of a second service and to ask said customer to respond;
determining said customer's response;
in response to said customer's response, activating said second service; and
setting up a billing method so that said customer will be charged for said second service.

2. The method of claim 1, wherein determining said customer's response includes collecting at least one voice sample.

3. The method of claim 2, wherein an automated speech recognizer is used to identify the contents of at least part of said voice sample.

4. The method of claim 1, wherein said first service is a method for placing a telephone call to another person.

5. The method of claim 1, wherein said determining a customer's response includes means for detecting touch-tones.

6. The method of claim 1, wherein said determining a customer's response includes means for recognizing spoken input.

7. The method of claim 1, wherein said second service is offered at a discounted rate for an introductory period.

8. The method of claim 1, wherein said second service is offered for free during an introductory period.

9. The method of claim 1, wherein said second service is one or more of the following: a method for placing a telephone call to another person, a method for listening to voicemail, a subscription to a mobile telephone service plan, a new pricing plan for said first service, basic telephone service, long-distance telephone service, flat-rate telephone service, wake-up calls, calendar management, call waiting, smart dial-tone, call screening, VoIP service, peer-to-peer telephone service, voice dialing, voicemail, automated attendant or receptionist services, a service that reads email using a text-to-speech synthesizer, a news service that reports weather, sports, or other news, an automated assistant, a stock quoting and/or trading service, video telephone service, horoscopes or other entertainment, or a new pricing plan for an existing service such as a lower per-minute charge with an additional monthly fee, or a click-to-talk service.

10. A system for selling telephone services, comprising:
a first platform adapted to provide a first service to a caller;
an up-sell platform coupled to one or more configuration systems, the up-sell platform configured to offer one or more services to said caller while said caller is using said first service;
one or more configuration systems coupled to said up-sell platform and configured to set up one or more services for said caller; and
a billing system adapted to initiate charges for said caller.

11. The system of claim 10 further comprising a speech recognizer configured to understand spoken responses from said caller.

12. The system of claim 10 further comprising a DTMF recognizer configured to understand spoken responses from said caller.

13. The system of claim 10 further comprising a DTMF/speech recognition recognizer configured to understand spoken responses and DTMF input from said caller.

14. The system of claim 10 wherein said billing system includes a platform adapted to collect billing information from said customer.
